(19) United States
(12) Patent Application Publication
(10) Pub. No.: US 2023/0050086 A1
(43) Pub. Date: Feb. 16, 2023

(54) APPARATUS THAT IMPROVES VISION

(71) Applicant: Gerald Stulberger, Hewlett, NY (US)

(72) Inventor: Gerald Stulberger, Hewlett, NY (US)

(21) Appl. No.: 17/401,136

(22) Filed: Aug. 12, 2021

(51) Int. Cl. G02C 5/22

(52) U.S. Cl. CPC G02C 5/22

(57) ABSTRACT

An apparatus includes a frame, a left temple, a right temple, a left end piece, a right end piece, a left hinge, and a right hinge. The frame includes a left side and a right side, and the frame may support a lens. The apparatus frame that improves vision may be tilted to supply the lenses at varying angles and lock into place via a latching mechanism. The effect of the tilted lens provides significantly increased clarity and definition of vision, with no expensive custom lenses or magnification.

### CROSS-REFERENCE TO RELATED APPLICATION

The present application is related to and claims priority to U.S. Provisional Patent Application No. 63/065,385 filed Aug. 30, 2020, which is incorporated by reference herein in its entirety.

### BACKGROUND OF THE INVENTION

The following includes information that may be useful in understanding the present disclosure. But is not an admission that any of the information supplied here is prior art nor material to the presently described or claimed inventions, nor that any publication or document that is expressly or implicitly referenced is prior art.

### FIELD OF THE INVENTION

The present invention generally relates to the field of eyewear and more specifically relates to rotatable eyeglasses.

### DESCRIPTION OF RELATED ART

A corrective lens is worn in front of an eye, mainly used to treat myopia, hyperopia, astigmatism, and presbyopia. Glasses are worn on the face a short distance in front of the eye to improve sight. People using a typical pair of magnifier readers or glasses to read have found that tipping a pair of glasses to a different angle will substantially decrease eye fatigue and improve eye focus. Unfortunately, a typical pair of reading glasses is designed using a ridged mounting point at the point where the lenses are attached to the temple part of the eyeglass frame. Because of this typical design of eyeglasses, when a user tips a pair of glasses about their head and face to improve the lens angle for better eye comfort and focus, the eyeglasses are perched in an unstable position on the user's head, and the user is constantly having to adjust or hold the eyeglasses from falling off entirely. A suitable solution is desired.

U.S. Pub. No. 2006/0256282 to Eiichi Nakanishi relates to a frame of a pair of multiple-focus spectacles. The described frame of a pair of multiple-focus spectacles includes a frame of a pair of multiple-focus spectacles which has temples, each connected by a vertical swiveling mechanism with a horizontal pivot, to a web on the outer side of a forward frame part. A retainer built in this mechanism has a pawl adjoining to the frame part, and an arcuate row of notches are formed within the temple around the pivot to alternatively engage with the pawl. A compression spring urges the pawl to be kept in the chosen notch, and the temple can be pulled simply against the spring so that the pawl disengages from one notch and then engages with another notch. Each temple is securely kept at any downwardly slanted or regular straight position compared to the frame part.

### BRIEF SUMMARY OF THE INVENTION

Given the preceding disadvantages inherent in the known eyewear art, the present disclosure supplies a novel apparatus that improves vision. Therefore, the general purpose of the present disclosure, which will be described later in greater detail, is to supply an apparatus that improves vision allowing a user to pivot lenses to the desired angle.

The disclosed apparatus that improves vision includes a frame, a frame front, a left temple, a right temple, a left end piece, a right end piece, a left hinge, a right hinge, a lower-left hinge, and a lower-right hinge. The frame includes a left side and a right side. The frame front includes a left side and a right side, which may support lenses. The left side of the frame front is attached to the left side of the frame with the left hinge. The right side of the frame front is attached to the right side of the frame. The left temple includes an elongate body having a first end and a second end. The second end of the left temple is removably attached to the left side of the frame. The right temple includes an elongate body and has a first end and a second end, and the second end of the right temple is attached to the right side of the frame.

The lens holder tilts on a hinge between it and the frame front having the means to tilt a lens provides significantly increased clarity and definition of vision, with no expensive custom lenses or magnification. In addition, the device eases eyestrain when reading small text or viewing finely detailed items by supplying pivoting eyewear.

To summarize the invention, certain aspects, advantages, and novel features of the invention have been described here. It is to be understood that not necessarily all such advantages may be achieved following any one embodiment of the invention. Thus, the invention may be embodied or carried out in a manner that achieves or perfects one advantage or group of advantages as taught here without necessarily achieving other advantages as may be taught or suggested here. The features of the invention which are believed to be novel are particularly pointed out and distinctly claimed in the concluding part of the specification. These and other features, aspects, and advantages of the present invention will become better understood regarding the following drawings and detailed description.

### BRIEF DESCRIPTION OF THE DRAWINGS

The figures that go with the written part of this specification illustrate embodiments and methods of use for the present disclosure, an apparatus that improves vision, constructed and operative according to the teachings of the present disclosure.

FIG. 1 is a perspective view of the apparatus that improves vision during an in-use condition, according to an embodiment of the disclosure.

FIG. 2 is a perspective view of apparatus of FIG. 1, according to an embodiment of the present disclosure.

FIG. 3 is a perspective view of apparatus of FIG. 1, according to an embodiment of the present disclosure.

FIG. 4 is a perspective view of apparatus of FIG. 1, according to an embodiment of the present disclosure.

FIG. 5 is a perspective view of an alternative apparatus according to the present disclosure.

The various embodiments of the present invention will be described in conjunction with the appended drawings, wherein like designations denote like elements.

### DETAILED DESCRIPTION

As discussed above, embodiments of the present disclosure relate to axially rotatable eyewear and, more particularly, an apparatus that improves vision by supplying adjustable lenses for improving sight (the efficient use of sight).

Apparatus can tilt and stop and secure the lenses into place, in some embodiments, using stops on a rotating shaft. For example, a tilt angle position may include three angles in the 40-80-degree range tilted forward, as desired by the wearer of the glasses. The lenses then may be released with a slight push forward, disengaging the stops on the rotating shaft once the wearer no longer wants the tilt effect.

The effect of the tilted lens provides significantly increased clarity and definition of vision, with no expensive custom lenses or magnification. The device also significantly eases eyestrain when reading, e.g., fine print and viewing fine textures, cellphones, or tablet screens. The apparatus may increase clarity and readability in dimmed lighting as well.

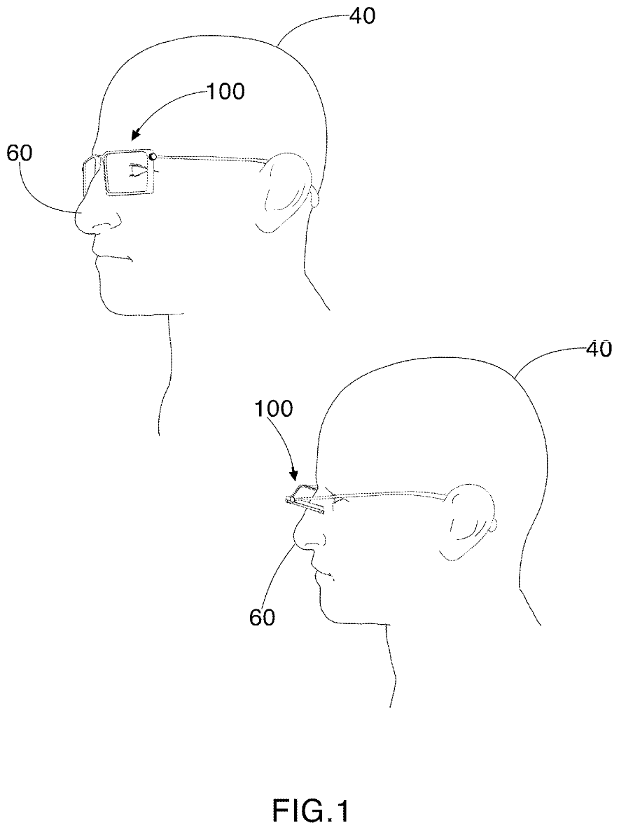

Referring now more specifically to the drawings by numerals of reference, there is shown in FIGS. 1-4, various views of an apparatus that improves vision 100. According to an embodiment of the present disclosure, FIG. 1 shows an apparatus that improves vision 100 during an in-use condition.

As illustrated, apparatus 100 includes a frame front 110, a left temple 118, a right temple 126, a left end piece 134, a right end piece 136, a left hinge 138, and a right hinge 142. Frame front 110 includes a left side 112 and a right side 114, and frame front 110 may support a lens 116. The left temple 118 includes a left elongate body 120 having a first end 122 and a second end 124. The second end 124 of the left temple 118 is removably attached to the left side 112 of the frame front 110. The right temple 126 includes a right elongate body 128 and has a first end 130 and a second end 132. The second end 132 of the right temple 126 is removably attached to the right side 114 of the frame front 110. The left end piece 134 is rotatably positioned between the left side 112 of the frame front 110 and the second end 124 of the left temple 118. The right end piece 136 is rotatably positioned between the right side 114 of the frame front 110 and the second end 132 of the right temple 126. The left hinge 138 being positioned in a middle portion 140 of the elongate body 120 of the left temple 118. The right hinge 142 being positioned in a middle portion 144 of the elongate body 128 of the right temple 126.

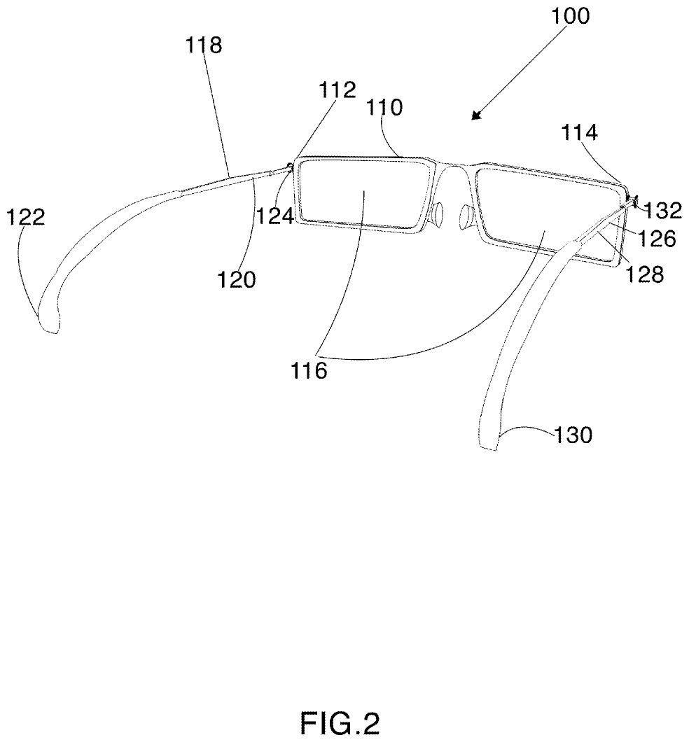

FIG. 2 shows a perspective view of apparatus 100 of FIG. 1, according to an embodiment of the present disclosure. As above, apparatus 100 includes the frame front 110, the left temple 118, the right temple 126, the left end piece 134, the right end piece 136, the left hinge 138, and the right hinge 142. The frame front 110 of apparatus 100 is configured to be tilted from a first position to other positions using a latching mechanism. The latching mechanism may have several protruding members 146, including teeth or stops. The apparatus 100 further includes a left nose pad 148 and a right nose pad 150 configured to rest on a nose 60 of a user 40. The left nose pad 148 and the right nose pad 150 are configured to be horizontally adjusted. The left nose pad 148 and the right nose pad 150 are configured to be vertically adjusted. The positions of tilt are incremental. One of the tilt positions includes an angle measuring between 40 degrees and 60 degrees to a user's face 40. Other angles may be used.

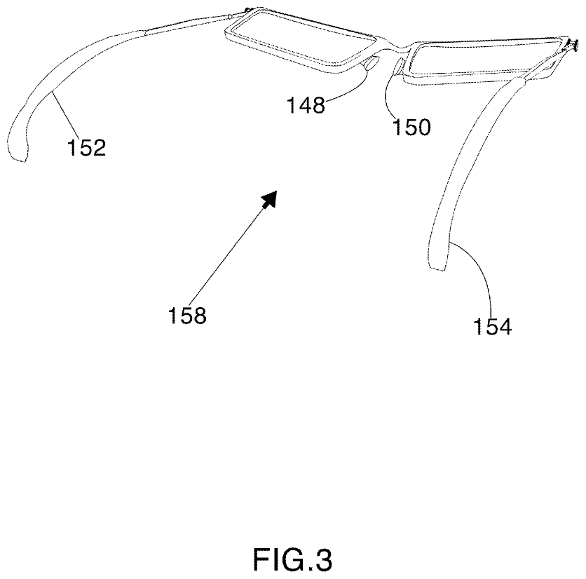

FIG. 3 shows a perspective view of apparatus 100 of FIG. 1, according to an embodiment of the present disclosure. As above, apparatus 100 includes frame front 110 configured to support lenses 116. lenses 116 may be auto-dimming lenses. The lenses 116 are removable and scratch-resistant in some embodiments, configured to supply ultra-violet ray protection. In addition, the lenses 116 may be shatter-proof and have an anti-glare coating.

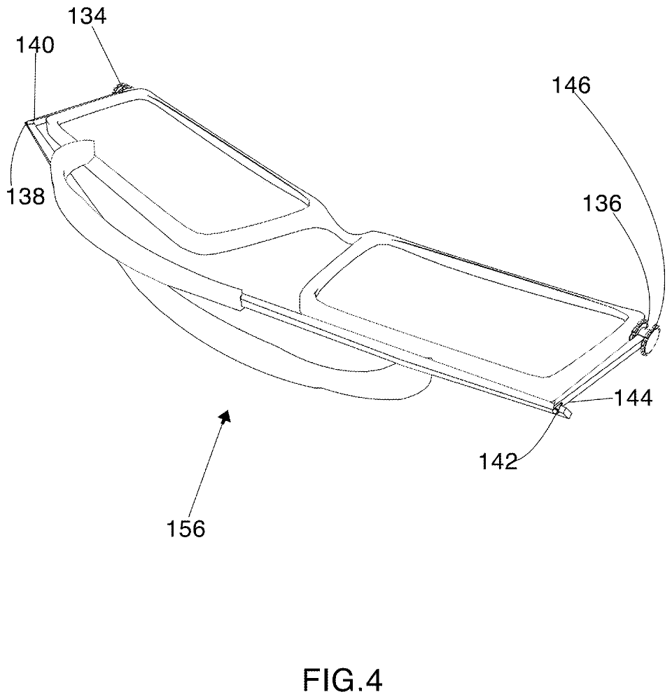

FIG. 4 shows a perspective view of apparatus 100 of FIG. 1, according to an embodiment of the present disclosure. As above, apparatus 100 is foldable. The apparatus 100 further includes a left temple cover 152; the left temple cover 152 may be removably attached to the first end 122 of the left temple 118 and configured to supply padding to a left ear of a user 40. The apparatus may further include a right temple cover 154; the right temple cover 154 is removably attached to the first end 130 of the right temple 126 and configured to supply padding to a right ear of the user 40. The left hinge 138 and the right hinge 142 are configured to supply pivotal movement of the left temple 118 and the right temple 126 from an open configuration to a closed configuration and from a closed configuration to an open configuration. A method of use may include using the described apparatus to promote ease of vision via tilting to supply the lenses at varying angles compared to the eye and lock into place via a latching mechanism.

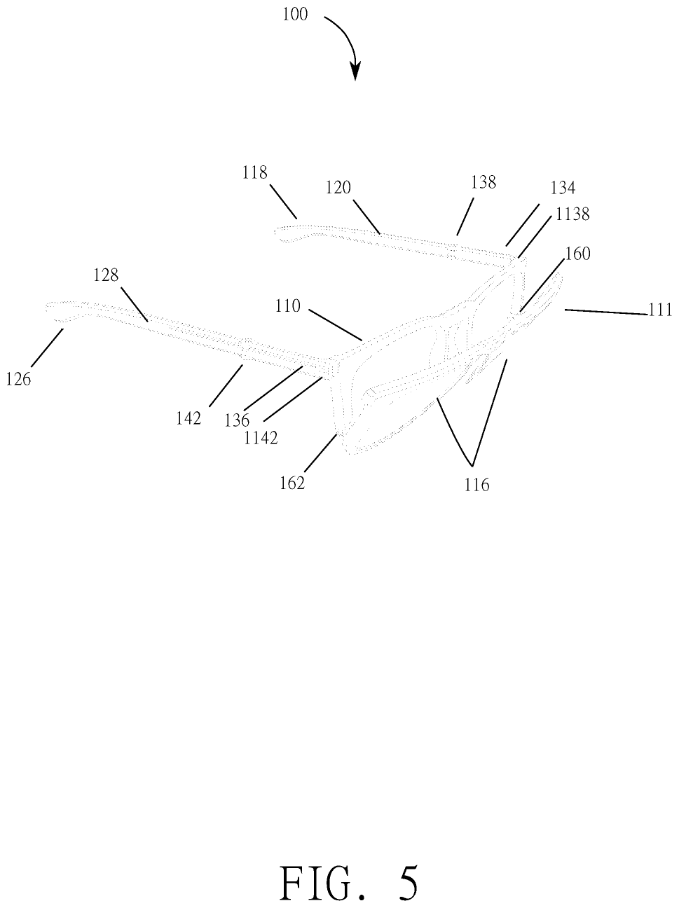

FIG. 5 shows a perspective view of apparatus 100 of FIG. 1 according to an embodiment of the present disclosure. As above, apparatus 100 includes the frame front 110, the lens holder 111 connected to the left temple 118 through hinge 1138, and the right temple 126 through hinge 1142. The left temple 118 includes the left end piece 134. The right temple 126 includes the right end piece 136 and the right hinge 142. The frame front 110 is attached to the lens holder 111 with the lower-left hinge 160 and the lower-right hinge 162. The positions of tilt are incremental. One of the tilt positions includes an angle measuring between 40 degrees and 60 degrees to a user's face 40. Other angles may be used.

The embodiments of the invention described here are exemplary and many modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to decide quickly from a cursory inspection the nature and essence of the technical disclosure of the application.

What is claimed is:

1. Eyeglasses comprising a frame having
a frame front,
a left temple with a left elongate body connected to the left side of the frame front,
a right temple with a right elongate body connected to the right side of the frame front,
and
a lens holder containing lenses connected to the frame front,
wherein the lens holder tilts on a pivot axis.

2. The eyeglasses of claim 1, having a fold-flat position wherein the left temple, the left elongate body, the right temple, and the right elongate body lie in a plane containing the frame.

3. The eyeglasses of claim 2 having a tilted position wherein the lens holder tilts downward.

4. The eyeglasses of claim 3, wherein in the tilted position the lens holder tilts pantascopically.

5. The eyeglasses of claim 4, wherein the tilted position encompasses a plurality of positions.

6. The eyeglasses of claim 5, wherein the frame front does not contain lenses.

7. The eyeglasses of claim 6, wherein the frame front has a bottom edge near a bottom edge of the lens holder.

8. The eyeglasses of claim 7 further comprising a hinge between the frame front and the bottom edge of the lens holder.

9. The eyeglasses of claim 8, wherein the hinge defines the pivot point.

10. The eyeglasses of claim 9 further comprising a second hinge between the lower edge of the frame front and the bottom edge of the lens holder.

11. The eyeglasses of claim 10, wherein one of the tilted positions has a tilt angle measuring 40-60 or 70-80 degrees from a first position.

12. The eyeglasses of claim 11 further comprising a right midpoint hinge disposed along the right elongate body and a left midpoint hinge disposed along the left elongate body.

13. The eyeglasses of claim 12 further comprising a left hinge between a left end piece of the left temple and a right hinge between a right end piece of the right temple.

14. The eyeglasses of claim 12, wherein the midpoint hinges are disposed nearer the anterior end of the temples than to the posterior end of the temples.

15. The eyeglasses of claim 14, wherein one of the tilted positions has a tilt angle measuring 40-80, 40-60, or 70-80 degrees from a user's face.

16. The eyeglasses of claim 14, wherein one of the tilted positions has a tilt angle measuring 40-80, 40-60, or 70-80 degrees from vertical.

17. Eyeglasses comprising a frame having
a frame front has a bottom edge and does not have lenses,
a left temple with a left elongate body connected to the left side of the frame front,
a right temple with a right elongate body connected to the right side of the frame front,
a lens holder containing lenses connected through a hinge near the bottom edge of the frame front,
a right midpoint hinge disposed along the right elongate body,
a left midpoint hinge disposed along the left elongate body,
a left hinge between a left end piece of the left temple,
a right hinge between a right end piece of the right temple,
a left hinge between a left end piece of the left temple,
and
a right hinge between a right end piece of the right temple,
wherein
the lens holder tilts on a pivot axis defined by the hinge,
the eyeglasses have a fold-flat position wherein the left temple,
the left elongate body, the right temple, and the right elongate body lie in a plane containing the frame,
the eyeglasses have a tilted position wherein the lens holder tilts downward, pantascopically, in a plurality of positions, at least one of which has a tilt angle measuring 40-80 degrees from a user's face.
